(19) United States
(12) Patent Application Publication
(10) Pub. No.: US 2004/0108970 A1
(43) Pub. Date: Jun. 10, 2004

(54) Vehical graphical message display system

(76) Inventor: Brian Clark Nealon, Houston, TX (US)

Correspondence Address: Sonya C. Harris, Agent for Applicant, PO Box 2607, Fairfax, VA, 22031, US

(21) Appl. No.: 10/309,062

(22) Filed: Dec. 4, 2002

(51) Int. Cl. G09G 5/00

(52) U.S. Cl. 345/1.2

(57) ABSTRACT

The present invention features a graphical message display system for vehicles. A visual display system having an array of light sources adapted for textual, graphical message displays. This system has three major components: the visual display device, and interfacing module, and a power adapter. The visual display device is capable of displaying alphanumerical and/or graphical messages in a stationary, flashing, or scrolling manner. The display device is comprised of an array of light sources in conjunction with microlenses emitting radiation in visual spectrum. The visual display device is adapted to fit into windows and/or windshields of vehicles for a wide variety of lighted signage applications.

### FIELD OF THE INVENTION

The present invention relates to a lighted display apparatus and, more particularly, to a lighted graphical display apparatus for use in automotive applications.

### BACKGROUND OF THE INVENTION

### DISCUSSION OF THE PRIOR ART

The prior art is replete with devices employing light emitting devices. U.S. Pat. No. 5,895,115, to Parker, et. al, issaued Jun. 27, 2000, for Light Emitting Panel Assemblies for Use in Automotive Applications and the Like teaches of such a device. Herein, a flexible lighted assembly is disclosed for use in automobiles such as brake lights or such.

U.S. Pat. No. 5,396,350, issued on Mar. 7, 1995, to Beeson, et. al, for a Backlighting Apparatus Employing an Array of Microprisms teaches of a slab waveguide device that accepts light rays generated by a light source and transmits the light rays via total internal reflection. An array of microlenses are positioned to accept the light exiting from the microlenses in a substantially perpendicular manner for enhanced lighting.

Parker, et al. issued on Jun. 27, 2000, as U.S. Pat. No. 6,079,838, discloses Light Emitting Panel Assemblies. This patent teaches of increasing the efficiency of light entering an exit panel for emitting light. A plurality of panel assemblies including light emitting surfaces along the length of the panel members are used. A uniform light output distribution is thus produced with a pattern of light void of deformities.

In the U.S. patent to Fisher (U.S. Pat. No. 6,217,186), issued Apr. 17, 2001, the disclosure is directed to an illuminated display assembly having a transparent sheet of material and a light source and an array of lights arranged so as to distribute light from the light source. This apparatus is designed to increase light intensity issuing from a display particularly in the region remote from the light source.

The U.S. patent to Ryan, Jr., et, al. (U.S. Pat. No. 6,244,727) issued on Jun. 12, 2001, teaches of a low loss optic lens apparatus having a plurality of light sources such as LED's mounted to a board capable of being electrically connected to a power source. A lens is attached to the board in a spaced apart relationship. A plurality of cells are combined into an array, arranged into a housing for forming lighted displays.

None of these patents either teaches or suggests a display system having an array of light sources adapted for graphical message displays for automobile usage. As will be seen in greater detail hereinafter, the present invention involves a system having a means for programming specific messages to be displayed on a display means consisting of an array of lights. The messages can be displayed in various modes including flashing, scrolling or stationary lettering to gain attention of an on-looker.

### SUMMARY OF THE INVENTION

The present invention features a graphical message display system for vehicles. A visual display system is disclosed having an array of light sources adapted for textual, graphical message displays. This system has three major components: the visual display device, an interfacing module, and a power adapter. The visual display device is capable of displaying alphanumerical and/or graphical messages in a stationary, flashing, or scrolling manner. The display device is comprised of an array of light sources in conjunction with microlenses emitting radiation in visual spectrum. The visual display device is adapted to fit into windows and/or windshields of vehicles for a wide variety of lighted signage applications.

It is therefore an object of the invention to provide a graphical messaging display system for use in automobiles.

It is another object of the invention to provide a visual message display system adapted for textual and/or graphical messaging for vehicles.

It is also an object of the invention to provide a graphical messaging display system that may be programmed on site to display messages for on-lookers.

It is a further object of the invention to provide a graphical messaging display system for automobiles capable of message displays in a stationary, flashing or scrolling manner.

It is an additional object of the invention to provide a graphical messaging display system for vehicles that is portable and economical.

It is a still further object of the invention to provide a graphical messaging display system for vehicles employing an array of visible light sources for providing messages.

These and other objects, features and advantages will be more apparent from a study of the enclosed text and the appended drawings.

### BRIEF DESCRIPTION OF THE DRAWINGS

A complete understanding of the present invention may be obtained by reference to the accompanying drawings, when taken in conjunction with the detail description thereof and in which:

FIG. 1 is a diagrammatic view of the components of the vehicle graphical message display system.

FIG. 2 is an environmental view of the vehicle graphical message display system.

FIG. 3 shows a side view of the coherent light source as connected to an electrical circuit board in accordance with the present invention.

### DESCRIPTION OF THE PREFERRED EMBODIMENT

This disclosure of the invention is submitted in furtherance of the constitutional purposes of the U.S. Patent Laws “to promote the progress of science and useful arts” (Article 1, Section 8).

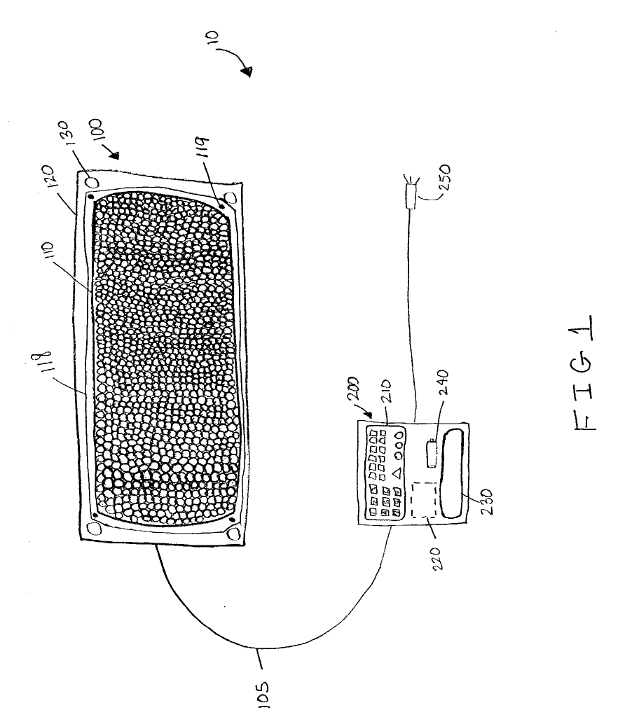

Referring now to FIGS. 1-3, there is illustrated a preferred embodiment of the Vehicle Graphical Messaging Display System (VGMDS) 10 of the present invention. The VGMDS 10 comprises at least three major components of operation. These components are the visual display device (VDD) 100, the interface module (IM) 200 and means for connecting to power, the power adapter 250.

The VDD 100 comprises an array 110 of light assemblies 109 that forms the visual platform for the means of display. For purposes of illustration and simplicity for this disclosure only, light emitting diodes (LEDs) will be understood herein as the preferred light source 112 of the light assemblies 109. Each LED 112 has a central axis of light emission, and the LEDs 112 are preferably oriented with their central axes generally parallel. Alternatively, LCDs, LCIDs, incandescent bulbs, cathode ray tubes, fluorescent light, electroluminescent light, lasers (or other coherent light sources), or other light sources known to those skilled in the art can be used or adapted for use with the present invention. It is to be understood that a greater or lesser number of LEDs 112 may be used.

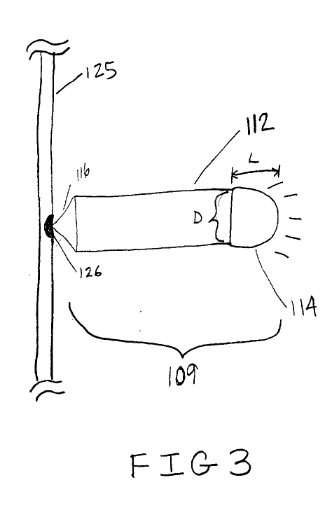

The light sources 112 are mounted to an electrical circuit board 125 with an adhesive or by other mounting methods known to those skilled in the art and electrically connected to a power source (not shown) such as an automobile battery, a photovoltaic cell, a generator, or the like by way of power adapter 250 having a 12/24 volt converter therein. As shown in FIG. 3, the board 125 is preferably a conventional circuit board with electric conductors embedded in the surface of the board 125 so that each light source 112 may be electrically connected thereto and all the light sources 112 on one board 125 may thus be electrically interconnected for coincidental operation.

Optionally, the light sources 112 and/or their wiring may extend through apertures defined in the board 125 for independent electrical connection to the power source so that each light source 112 may be individually operated. It should be noted that other arrangements may be suitably employed, such as electrically interconnecting the light sources 112 by conventional wiring. In such an arrangement, the board 125 may be made of a plastic, metal, ceramic, composite, or other material known to those skilled in the art.

Provided on each light source is a microlens 114 optically affixed thereto. The microlens 114 may be preferably molded from a polycarbonate or acrylic material. Optionally, the microlens 114 may be made of a thermoplastic resin or other material and fabricated by other methods known to those skilled in the art. The microlens 114 may be generally transparent or have a tint or other light filter for producing a visible color as may be desired in a given application.

The microlens 114, in conjunction with the light source 112, are preferably oriented in a generally perpendicular arrangement relative to board 125. The microlens 114 is preferably rigidly attached to the light source 112 via non-lossy bonding agents, resins, etc., or other mounting mechanisms known to those skilled in the art and selected to generally prevent movement of the microlens 114 relative to the light source 112 and to not interfere with light emminating therefrom. The board 125 and arrangement of light source 112 are preferably generally rectangular so that the resulting visual display device (VDD) 100 has a generally rectangular shape. Optionally, the VDD 100 may have a triangular, hexagonal, octagonal, or other regular or irregular shape known to those skilled in the art for retrofitting into windows of particular makes of automobiles.

The thickness of the microlenses 114 are selected to achieve a generally maximum intensity of the light source 112 and a generally minimum optic loss. The convex lens thickness and curvature are selected based on the desired index of refraction for the microlens 114.

The aperture diameter D is selected to allow high intensity light rays to be transmitted through a convexed microlens 114 without suffering optical losses that reduce the light intensity. The farther the convex microlens 114 extends in length L (lens thickness) from the light source 112, the greater must be the aperture diameter D. Generally, the aperture diameter D is preferably sufficiently large to allow lights rays of about a median magnitude of intensity and greater to pass through, based on a given lens/LED ratio spacing. Also, the aperture diameter D is preferably sufficiently small to prevent or discourage the intrusion and accumulation of insects, dirt, moisture, and other undesirable contaminants which reduce light transmission efficiency. In the preferred embodiment, the aperture diameter D, the lens thickness L, and the lens/LED spacing ratio are preferably approximately the same.

The plurality of light assemblies 109 (comprised of light source 112 coupled to microlens 114) may be formed together into the array 110 by various ways. Preferably, the circuit board 125 may be provided having female electrical plug receptacles for receiving male electrical plug prongs extending from the board 125 and electrically connected to the light assemblies 109 for a modular arrangement wherein light assemblies 109 may simply and easily be plugged and unplugged from the board 125 for replacements, and the like.

Alternatively, the light assemblies 109 may be mounted to the board 125 via electrical connector 116 within the housing 120 and formed as fasteners such as brackets, screws, or other fasteners (not shown) known to those skilled in the art.

A generally transparent thin cover 118 may be provided over the array 110 of light assemblies 109 and attached to the housing 120 for preventing the ingress of moisture, dirt, insects, and other undesired intrusions while imparting only minor, if any, optical losses to the light rays transmitted therethrough. Also, the housing 120 may be provided with a series of openings 119 for drainage of any moisture that intrudes into the array 110.

The interface module (IM) 200 is preferably attached to the VDD 100 via known electrical connectors such as a wire 105. Optionally, the IM 200 may be provided at a remote location. The IM 200 is electrically connected to the array 110 communicating electrical control signals via chip 220 to allow the controlled energization of light assemblies 109 as desired to provide a lighted message pattern. These patterns may include textual messaging relaying distress and the need for help, traffication signals common to vehicle operation, or any other messages relevant to driving. These messages may be preprogrammed into the IM 200 by an operator before installing the VGMDS 10 into a vehicle 500.

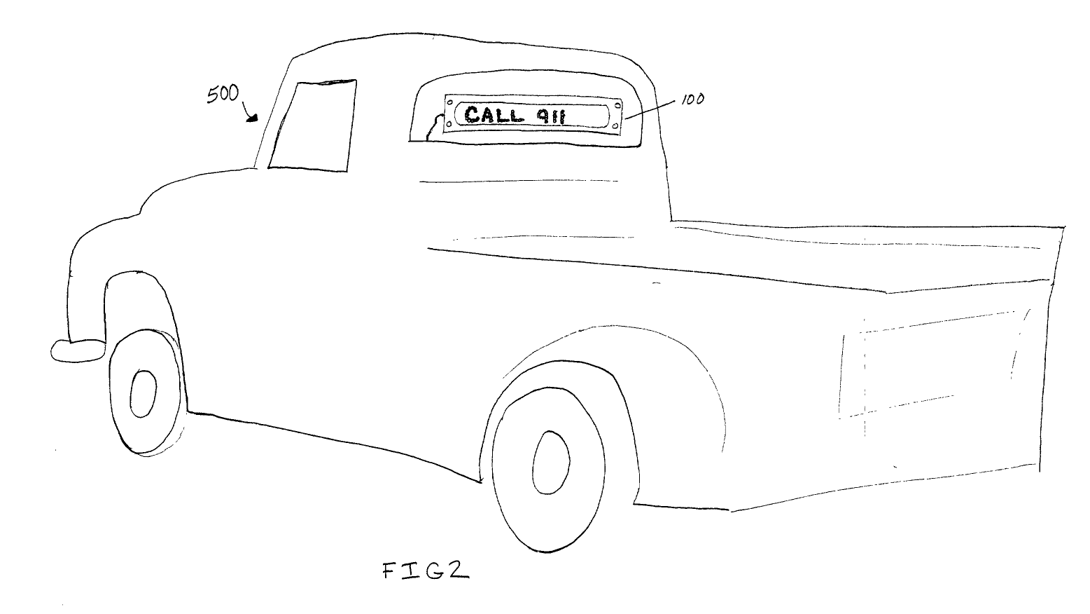

For operation of the VGMDS 10, the light assemblies 109 are combined into the array 110, electrically connected to the IM 200, and enclosed within the housing 120 to form an illuminating graphical or textual sign or signal 50 for vehicles 500, as shown in FIG. 2. As described hereinabove, all the components are either commercially available or are capable of being easily manufactured from readily available materials. The number, size, shape, and lens tint of the light assemblies 109 may be selected for any desired application. The light assemblies 109 of the array 110 are preferably generally uniform in shape and size and may be easily combined in the array 110 to form an illuminated signage with VDD 100 for any of a wide variety of lighting applications such as those described herein.

Since other modifications and changes varied to fit a particular operating requirements and environment will be apparent to those skilled in the art, the invention is not considered limited to the example chosen for purposes of disclosure, and covers all changes and modifications which do not constitute a departure from the true spirit and scope of the invention.

Accordingly, there are a number of advantages provided by the present invention. The light assemblies 109 are highly efficient in redistributing and focussing light rays so that a low intensity light source may be used to achieve the same light intensity as a higher intensity light source and/or the same intensity light may be produced using fewer light sources to achieve a smaller lens system. Each microlens 114 has a convex portion that provides the advantage of receiving light rays which may be directed in an undesired direction and redirecting these light rays by refraction in a desired direction. Additionally, each lens has an aperture defined therein that provides the advantage of transmitting lights rays therethrough that are directed in a desired direction without refraction and with minimal or no optical losses.

Having thus described the invention, what is desired to be protected by Letters Patent is presented in the subsequent appended claims.

What is claimed is:

1. A graphical message display system for vehicles, said system comprising:
a visual display device, said visual display device being comprised of a housing having an array of light sources housed therein, an electrical connection means for providing electrical coupling to said array, and attachment means for attaching said vehicle display device to a vehicle;
an interfacing means for electronically communicating control signals to said light sources for selectively illuminating said light sources to form graphical displays of signage on said visual display device, said interfacing means further having an input means for preprogramming messages for display on said visual display device; and
means for energizing said interfacing means.

2. The graphical message display system for vehicles as in claim 1, wherein
said interfacing means comprising a memory chip in communication with said input means, a display screen and a control panel; and
said memory chip containing preprogrammed messages, received by said input means, adapted for display on said visual display device.

3. The graphical message display system for vehicles as in claim 2, wherein
said means for energizing comprises a power adapter cord electrically connected to said interfacing means for coupling to external power sources.

4. The graphical message display system for vehicles as in claim 3, wherein
said means for energizing comprises on-site power means housed within said interfacing means.

5. The graphical message display system for vehicles as in claim 4, wherein
said control panel includes an alphanumeric keypad for programming textual messages for display on said visual display device.

6. The graphical message display system for vehicles as in claim 5 wherein,
said on-site power means comprises at least one battery.

7. The graphical message display system for vehicles as in claim 6, wherein
said on-site power means further comprises a 12/24 volt converter for vehicular operation.
